(19) United States
(12) Patent Application Publication
(10) Pub. No.: US 2019/0318220 A1
(43) Pub. Date: Oct. 17, 2019

(54) DISPERSED TEMPLATE-BASED BATCH INTERACTION WITH A QUESTION ANSWERING SYSTEM

(71) Applicant: International Business Machines Corporation, Armonk, NY (US)

(72) Inventors: Charles E. Beller, Baltimore (MD); William G. Dubyak, Severna Park, MD (US); Palani Sakthi, Palatine, IL (US); Kristen M. Summers, Takoma Park, MD (US); Hayes McCormick, Armonk, NY (US); Jay Oakey, Armonk, NY (US)

(21) Appl. No.: 15/952,828

(22) Filed: Apr. 13, 2018

(51) Int. Cl. G06N 3/00

(52) U.S. Cl. CPC G06N 3/006

(57) ABSTRACT

Embodiments are directed to interaction with an open-domain question and answer system to seek answers to broad and general questions by providing templates and words or phrases to fill slots in the templates that specify alternative specific questions, the answer to any of which may serve the broader purpose. Responses to all of the questions in a batch are considered as candidates, with the strongest general answers being returned. The approach, according to embodiments herein, addresses the need for responses to broad questions in which the user is seeking any response to a known pattern. The user is able to articulate the question as a template that can be instantiated in many forms, and the user may specify how strongly the concrete answers indicate an answer to the underlying general question.

### STATEMENT REGARDING FEDERALLY SPONSORED RESEARCH OR DEVELOPMENT

This invention was made with government support under 2013-12101100008 awarded by United States Defense Agencies. The government has certain rights to this invention.

### BACKGROUND

In a question and answer system, users typically input a single question at a time for processing. The system processes and responds to the user input question as it is asked. Any further elaboration of the intent, scope, and appropriate answers to the question occur as a matter of processing or refining the input question. In an open-domain question and answer system, specific questions may include any subject matter, and available knowledge resources are designed for general use rather than for detailed modeling of a specific phenomenon or area of knowledge.

### SUMMARY

Embodiments are directed to a computer-implemented method, a computer program product, and a system for answering general questions.

In an embodiment, the computer-implemented method is implemented in a system capable of answering questions, the system comprising a processor and a memory comprising instructions executed by the processor.

In an embodiment, the computer program product comprises a computer readable storage medium having program instructions embodied therewith, the program instructions executable by a processor.

In an embodiment, the processor executes the steps of: receiving a general question template and one or more sets of slot fillers with weights by a user; combining the one or more sets of slot fillers with the general question template to form questions; running the questions to obtain answers; aggregating the answers based on the weights; and returning at least one answer to the question to the user.

Additional features and advantages are apparent from the following detailed description that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a schematic diagram of an embodiment of a cognitive system implementing a question and answer (QA) generation system in a computer network;

FIG. 2 a block diagram illustrating components of and data flow in a system for answering general questions, according to an embodiment;

FIG. 3 is a representation of a sample question template and sets of fillers, according to an embodiment;

FIG. 4 is a representation of an exemplary weighted question batch, according to an embodiment;

FIG. 5 is a flowchart of a method for answering general questions in an information handling system capable of answering questions, in accordance with an embodiment;

FIG. 6 illustrates a question and answer system pipeline, of a cognitive system, as may be used with embodiments described herein; and

FIG. 7 is a block diagram of an example data processing system in which aspects of the illustrative embodiments are implemented.

### DETAILED DESCRIPTION

Due to typical question and answer systems processing individual user questions and seeking concrete, specific answers to these questions, a user with a general, abstract question may not receive any of the variety of factual responses that can answer the question. The user's intention in asking a broad question may be to find any response that satisfies one of several more specific forms that the question can take. Moreover, the user may have specific alternative questions in mind, but may wish to see the results as one cohesive set of responses.

For example, a user may ask about economic difficulties in a given country. This is a general inquiry about a phenomenon that can take a variety of specific, factual forms. With the input limited to this specific question, however, the traditional question and answer system either provides answers only for explicit statements of general economic difficulties in the country, or requires an extensive modeling of economic factors. Such extensive modeling is feasible only for highly constrained domains, not for an open-domain question and answer system.

However, according to embodiments provided herein, the user may articulate the question as a template that can be instantiated in many forms, such as “How much <X> is <Y> experiencing,” with potential fillers for X such as inflation, joblessness, and the like, and potential fillers for Y that identify populations and/or regions within a country. Additionally, the user may specify how strongly these concrete answers indicate an answer to the underlying general question; for example, indicating that joblessness is a more serious indicator of economic difficulties than inflation, leading to an intelligent ranking of the combined results.

Embodiments are thus directed to interaction with an open-domain question and answer system to seek answers to broad and general questions by providing templates and words or phrases to fill slots in the templates that specify alternative specific questions, the answer to any of which may serve the broader purpose. Responses to all of the questions in a batch are considered as candidates, with the strongest general answers being returned. The approach, according to embodiments herein, addresses the need for responses to broad questions in which the user is seeking any response to a known pattern. For example, continuing with the example of a user asking about economic difficulties in a given country, a corpus of news documents may not contain a direct statement of “economic difficulties,” but a user may be able to articulate a pattern of questions about inflation, employment, exchange rates, and similar topics of which there is typically direct reporting, the responses to which will form a meaningful and informative response to the original question.

Embodiments herein utilize a question and answer system that accepts as an input a question and returns a set of scored/ranked outputs, as further described in detail below. Reference herein to “scored answers” is intended to cover the scored/ranked outputs comprising one or more of answers and evidence passages/references.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situation awareness that mimics human cognition based on experiences
Answer questions based on natural language and specific evidence

In one aspect, cognitive systems provide mechanisms for answering questions posed to these cognitive systems using a Question Answering pipeline or system (QA system). The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area (e.g., financial domain, medical domain, legal domain, etc.) where the body of knowledge (knowledgebase) can be organized in a variety of configurations, e.g., a structured repository of domain-specific information, such as ontologies, or unstructured data related to the domain, or a collection of natural language documents about the domain.

Content users input questions to the cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using natural language processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e., candidate answer, is inferred by the question. This process is repeated for each of the candidate answers until the QA pipeline identifies candidate answers that surface as being significantly stronger than others and thus generates a final answer, or ranked set of answers, for the input question.

As mentioned above, QA pipeline and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e., candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identity documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify question and answer attributes of the content.

Operating on such content, the QA pipeline generates answers for input questions using a plurality of intensive analysis mechanisms which evaluate the content to identify the most probable answers, i.e., candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

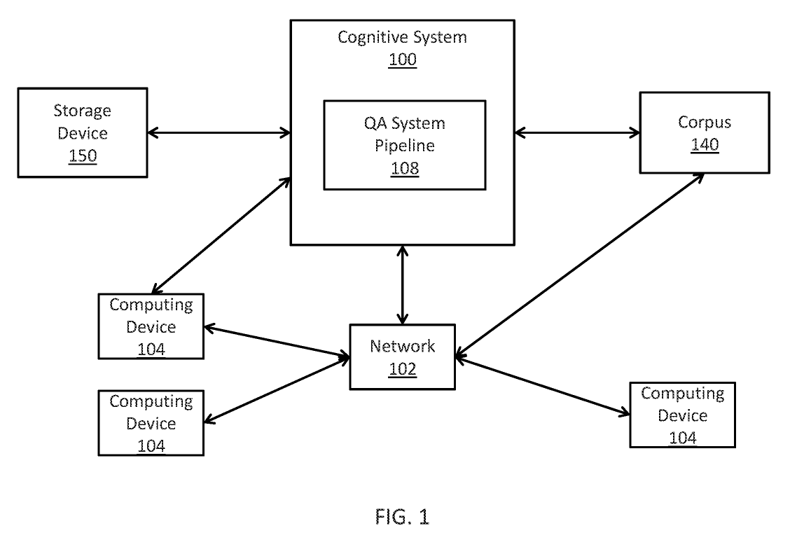

FIG. 1 depicts a schematic diagram of one illustrative embodiment of a cognitive system 100 implementing a question and answer (QA) pipeline 108 in a computer network 102. One example of a question/answer generation operation which may be used in conjunction with the principles described herein is described in U.S. Patent Application Publication No. 2011/0125734, which is herein incorporated by reference in its entirety. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question/answer (QA) generation functionality for one or more cognitive system users via their respective computing devices. Other embodiments of the cognitive system 100 may be used with components, systems, sub-systems, and/or devices other than those that are depicted herein.

The cognitive system 100 is configured to implement a QA pipeline 108 that receives inputs from various sources. For example, the cognitive system 100 receives input from the network 102, a corpus of electronic documents 140, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 140. Portions of the corpus of data 140 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 140 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 140. In one embodiment, the questions are formed using natural language. The cognitive system 100 parses and interprets the question via a QA pipeline 108, and provides a response to the cognitive system user containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

The cognitive system 100 implements the QA pipeline 108 which comprises a plurality of stages for processing an input question and the corpus of data 140. The QA pipeline 108 generates answers for the input question based on the processing of the input question and the corpus of data 140. The QA pipeline 108 is described in greater detail with regard to FIG. 8.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question, which it then parses to extract the major features of the question, and which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the QA pipeline of the IBM Watson™ cognitive system has regarding the evidence that the potential response, i.e., candidate answer, is inferred by the question. This process is repeated for each of the candidate answers to generate a ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare.” IBM developerWorks, 2011 and “The Era of Cognitive Systems: An Inside Look at IBM Watson and How it Works” by Rob High, IBM Redbooks, 2012.

As shown in FIG. 1, in accordance with some illustrative embodiments, the cognitive system 100 is further augmented, in accordance with the mechanisms of the illustrative embodiments, to include logic implemented in specialized hardware, software executed on hardware, or any combination of specialized hardware and software executed on hardware.

Results from the corpus 140 are stored in storage device 150 associated with either the cognitive system 100, where the storage device 150 may be a memory, a hard disk based storage device, flash memory, solid state storage device, or the like (hereafter assumed to be a “memory” with in-memory representations of the acyclic graphs for purposes of description).

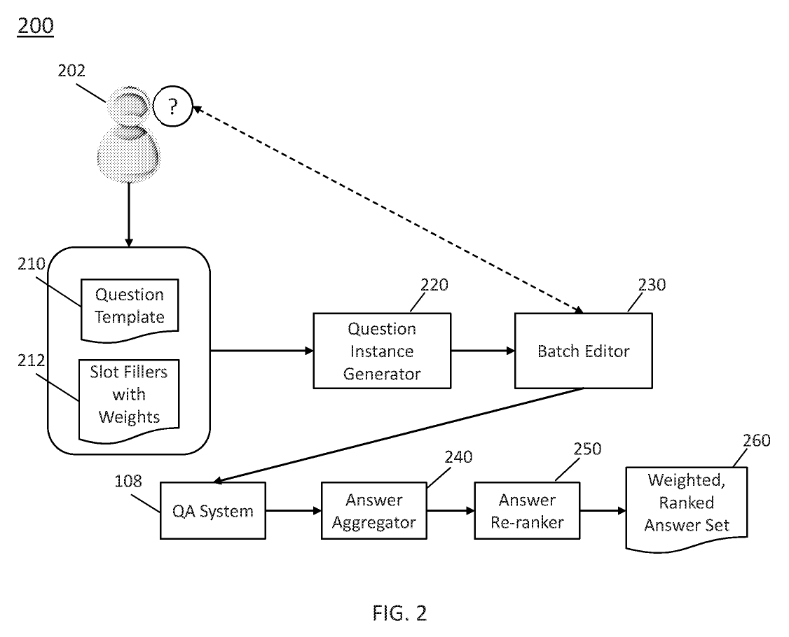

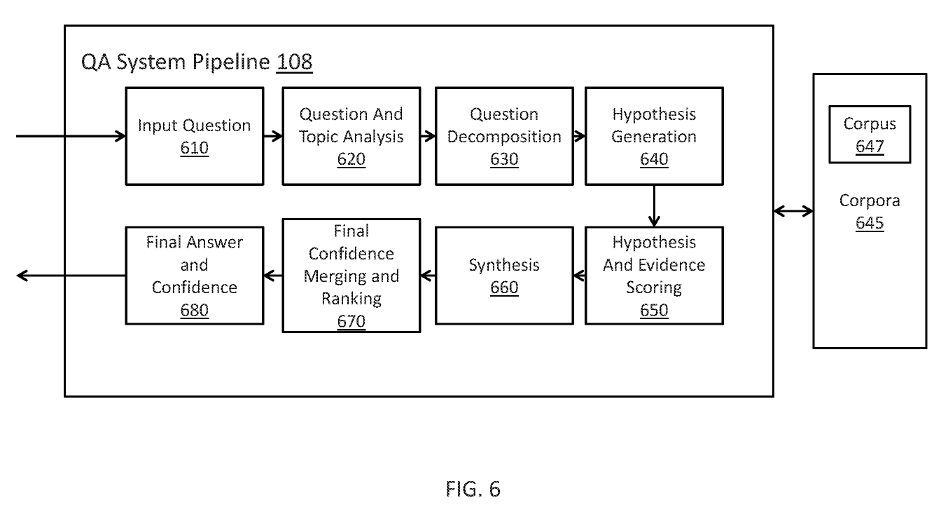

Now referring to FIG. 2, a block diagram 200 illustrates components of and data flow in a system for answering general questions, according to embodiments. An input question template 210 and one or more sets of fillers 212 are provided by a user 202, via a provided user interface. According to an embodiment, the input question template 210 includes blanks, and the sets of fillers 212 comprise fillers with user-provided weights for each blank in the template. Question instance generator 220 generates possible instantiations of the template with distinct combinations of slot fillers. A batch editor 230 creates a weighted question batch based on output by the question instance generator 220, with a weight on each question instantiation that combines the weights of its slot fillers. The weighted question batch is inputted to the QA system 108 (described in greater detail with regard to FIG. 6). The weighted question batch may also, according to an embodiment, be sent to the user 202 for confirmation or modification. The QA system 108 outputs answers to the weighted question batch to an answer aggregator 240, which aggregates the scored answers returned for each question. An answer re-ranker 250 re-ranks the generated answers based on weighting, to output a weighted, ranked answer set 260. Each component and step is described in further detail below.

As an input by the user 202, a question template 210 and one or more sets of fillers 212, with user-provided weights for the fillers, are provided. Each of the one or more sets of fillers 212 corresponds to one of the slots in the template 210. The question template 210 is in the form of a question, with some of the words replaced by empty slots. Each set of fillers 212 identifies a single slot and lists words and/or phrases that may be used to fill the slot, with weights to apply to each filler.

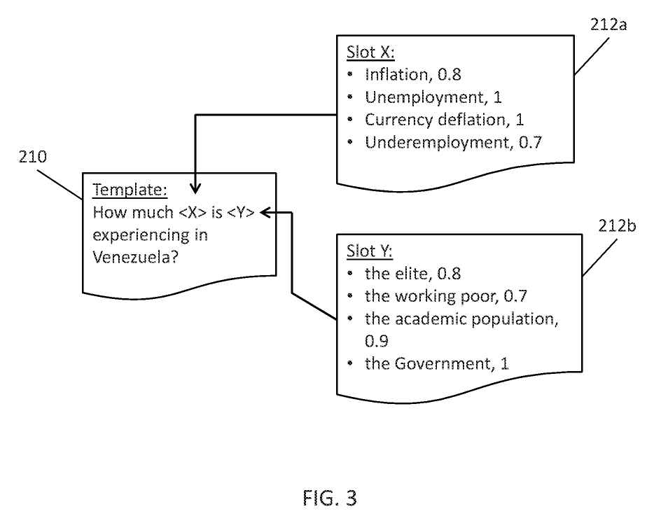

FIG. 3 is a representation of a sample question template 210 and sets of fillers 212a and 212b. According to an embodiment, a template 210 includes at least one slot. In an embodiment, there is no maximum number of slots. Each set of slot fillers 212 includes at least two options, in an embodiment. There is no maximum number of options, according to an embodiment. Slot filler options may comprise individual words and/or phrases.

According to an embodiment, a standard default weight for slot fillers may be defined, allowing the user 202 to specify weights only in cases that override this default. In another embodiment, a configuration may specify a discrete set of weights, such as “high”, “medium”, and “low”, for example, allowing the user 202 to specify these qualitative values. The qualitative values may be translated into specific quantitative values for further processing of the question described in detail herein. According to an embodiment, this may be combined with user specifications of precise quantitative weights.

With further reference to FIG. 2, the question instance generator 220 generates instantiations of the template 210 with distinct combinations of slot fillers with the one or more sets of filler 212. The instantiations are alternative concrete questions, the answers to which are likely to satisfy the original abstract, general question by instantiating combinations of slot fillers in the template 210.

For example, consider a situation in which the question template 210 includes k slots, s₁ through sₖ, and a function f maps each slot index i to the number of options in the filler set 212 in slot sᵢ, so that each slot has filler options sᵢ₍₁₎ through s_{i(f(i))}. f(1) x . . . x f(k) question instances are produced: one for each possible combination of a single choice from s₁₍₁₎ through s_{1(f(1))}, a single choice from s₂₍₁₎ through s_{2(f(2))} (if k>1), and a single choice from each of the remaining sᵢ₍₁₎ through s_{i(f(i))} slots up through sₖ.

The batch editor 230 forms a weighted question batch by applying, to each constructed question instantiation, a weight that combines the weights of its slot fillers. The combination of the weights of the slot fillers for a constructed question may be, for example, an average of the weights, a product of weights in a range [0, 1], or other more complex functions.

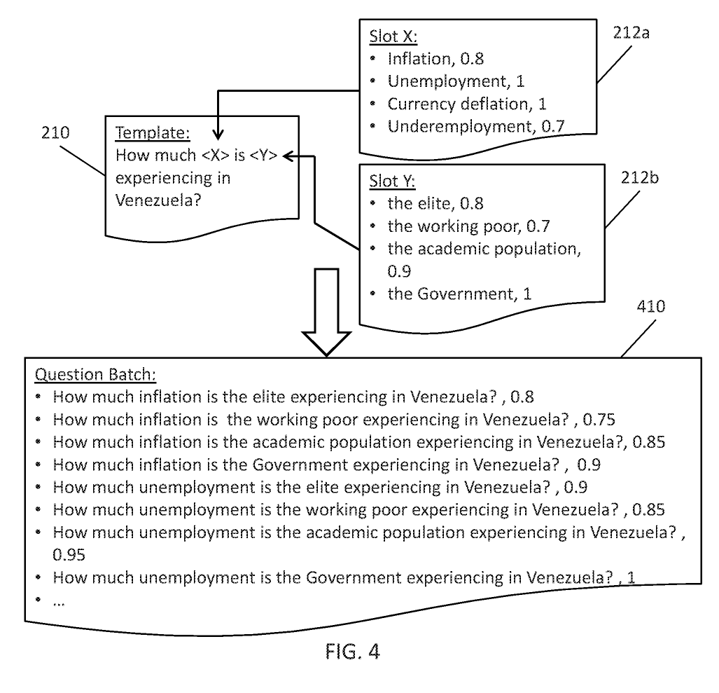

FIG. 4 is a representation of an exemplary weighted question batch 410 based on the example shown in FIG. 3. In this example, the slot weights are combined for the question by taking the average of the slot weights.

Turning back to system 200 of FIG. 2, the weighted question batch generated by the batch editor 230 may be, in an embodiment, provided to the user 202 to enable the user 202 to refine the batch of questions, if desired. The user 202, according to an embodiment, is notified of the weighted batch of question instances produced from the template 210 and sets of slot fillers 212. The user 202 may be provided with the opportunity to 1) accept the batch as constructed; 2) edit the batch by removing, changing, or adding questions or by adjusting weights; or 3) reject the batch and submit a revised template and slot fillers or a single question. The outcome of the action by the user 202 is inputted to the QA system 108. In an embodiment, a system configuration parameter may cause the user input step to be skipped, streamlining the user's experience.

The QA system 108 performs question answering on each question in the weighted batch of questions. Questions may be run in parallel.

The output of the QA system 108 is provided to the answer aggregator 240, which aggregates the scored answers and/or passages returned for each question.

The answer re-ranker 250 rescores and re-ranks the responses according to their scores in questions in the batch and the weights of those questions. According to an embodiment, responses to the questions in the batch are compared. Answers that are deemed equivalent are merged. In an embodiment, answers that are completely identical to one another are merged. In another embodiment, a broader comparison, such as a measurement of string similarity or a synonym lookup, may be used to identify answers to merge. Merged responses are scored with the maximum score from any of the individual responses being merged, according to an embodiment. The remaining responses retain their scores from their individual question instances. Then, all scores are scaled by the weight of the question instance that produced the score. The answer re-ranker 250 re-ranks the responses in a single list, according to the scores from this process.

The result is a weighted, ranked answer set 260, which is returned to the user 202 in the new order with an indication of the question instances in the batch that returned or produced the answer.

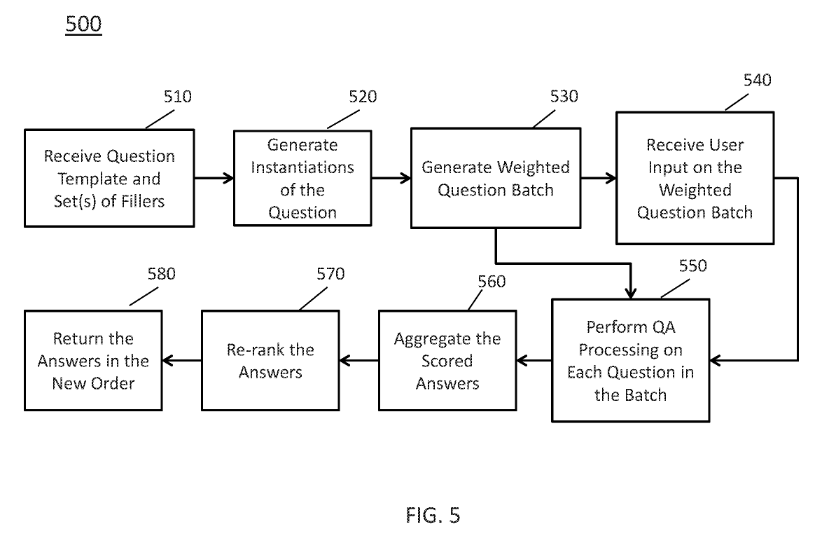

FIG. 5 is a flowchart 500 illustrating a method for answering general questions, in accordance with embodiments described herein.

At 510, a question template 210 and one or more sets of fillers 212 are received as inputs. In an embodiment, user-provided weights for the fillers are provided.

At 520, instantiations of the question template 210 with distinct combinations of slot fillers are generated by the question instance generator 220.

At 530, the batch editor 230 generates a weighted question batch based on output by the question instance generator 220, with a weight on each question instantiation that combines the weights of its slot fillers.

At 540, user-input on the weighted question batch is received. As described above, the user 202 may accept the batch as constructed; edit the batch; or reject the batch and resubmit a revised template and slot fillers or a single question. The outcome of the decision of the user 202 becomes the input to the QA system 108.

At 550, question-answering by the QA system 108 is performed on each question in the batch. 550 may proceed from 540 by processing the batch accepted, edited, or rejected (i.e., the original question) by the user, or from 530 if user input is not performed.

At 560, the scored answers from the QA system 108 are aggregated by the answer aggregator 240.

At 570, the answer re-ranker 250 rescores and re-ranks the responses according to their highest score for any questions in the batch, scaled by the individual question weight.

At 580, the answers are returned in the new order, with an indication of the question instances that returned each one.

The system and methods for answering general questions, according to embodiments herein, advantageously provide a question template and fillers, rather than an individual question, to generate concrete alternative instances to a general question. The weighting of slot fillers and resulting weighting of the generated instantiations reflects a user's intent. Moreover, further used feedback may be incorporated by providing the user with the generated weighted question batch. The re-ranking, according to embodiments herein, based on the weighting of the individual questions in the batch provides a convenient, usable weighted, ranked answer set to the user.

FIG. 6 illustrates a QA system pipeline 108, of a cognitive system, for processing an input question. The QA system pipeline 108 of FIG. 6 may be implemented, for example, as QA pipeline 108 of cognitive system 100 in FIG. 1. It should be appreciated that the stages as shown in FIG. 6 are implemented as one or more software engines, components, or the like, which are configured with logic for implementing the functionality attributed to the particular stage. Each stage is implemented using one or more of such software engines, components or the like. The software engines, components, etc., are executed on one or more processors of one or more data processing systems or devices and utilize or operate on data stored in one or more data storage devices, memories, or the like, on one or more of the data processing systems. Additional stages may be provided to implement the improved mechanism, or separate logic from the pipeline 108 may be provided for interfacing with the pipeline 108 and implementing the improved functionality and operations of the illustrative embodiments provided herein.

As shown in FIG. 6, the QA pipeline 108 comprises a plurality of stages 610-680 through which the cognitive system operates to analyze an input question and generate a final response. In an initial question input stage 610, the QA pipeline 108 receives an input question that is presented in a natural language format. That is, a user inputs, via a user interface, an input question for which the user wishes to obtain an answer, e.g., “Who are Washington's closest advisors?” In response to receiving the input question, the next stage of the QA pipeline 108, i.e., the question and topic analysis stage 620, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referenced to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “What drug” since this phrase can be replaced with the answer, e.g., “Adderall,” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 6, the identified major features are then used during the question decomposition stage 630 to decompose the question into one or more queries that are applied to the corpora of data/information 645 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 645. That is, these various sources themselves, different collections of sources, and the like, represent a different corpus 647 within the corpora 645. There may be different corpora 647 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 647 within the corpora 645.

The queries are applied to one or more databases storing information about the electronic texts, documents, articles, websites, and the like, that make up the corpus of data/information, e.g., the corpus of data 140 in FIG. 1. The queries are applied to the corpus of data/information at the hypothesis generation stage 640 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 640, to generate hypotheses for answering the input question. These hypotheses are also referred to herein as “candidate answers” for the input question. For any input question, at this stage 640, there may be hundreds of hypotheses or candidate answers generated that may need to be evaluated.

The QA pipeline 108, in stage 650, then performs a deep analysis and comparison of the language of the input question and the language of each hypothesis or “candidate answer,” as well as performs evidence scoring to evaluate the likelihood that the particular hypothesis is a correct answer for the input question. As described in FIG. 1, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e., a measure of confidence in the hypothesis. There are various ways of generating such scores depending upon the particular analysis being performed. In general, however, these algorithms look for particular terms, phrases, or patterns of text that are indicative of terms, phrases, or patterns of interest and determine a degree of matching with higher degrees of matching being given relatively higher scores than lower degrees of matching.

In the synthesis stage 660, the large number of scores generated by the various reasoning algorithms are synthesized into confidence scores or confidence measures for the various hypotheses. This process involves applying weights to the various scores, where the weights have been determined through training of the statistical model employed by the QA pipeline 108 and/or dynamically updated. For example, the weights for scores generated by algorithms that identify exactly matching terms and synonyms may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 108 that identifies a manner by which these scores may be combined to generate a confidence score or measure for the individual hypotheses or candidate answers. This confidence score or measure summarizes the level of confidence that the QA pipeline 108 has about the evidence that the candidate answer is inferred by the input question, i.e., that the candidate answer is the correct answer for the input question.

The resulting confidence scores or measures are processed by a final confidence merging and ranking stage 670 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 680, a final answer and confidence score, or final set of candidate answers and confidence scores, are generated and output to the submitter of the original input question via a graphical user interface or other mechanism for outputting information.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

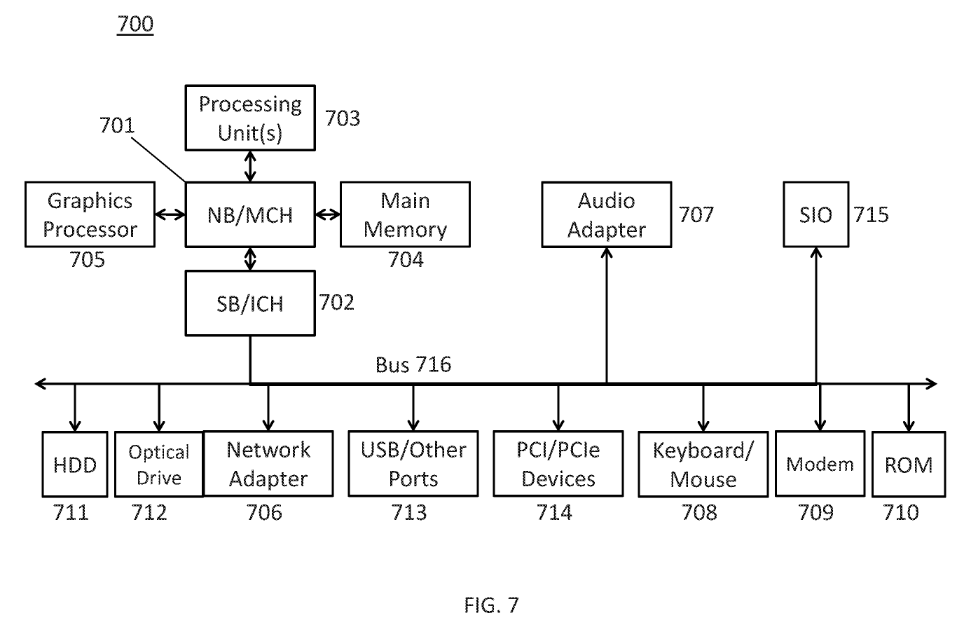

FIG. 7 is a block diagram of an example data processing system 700 in which aspects of the illustrative embodiments are implemented. Data processing system 700 is an example of a computer, such as a server or client, in which computer usable code or instructions implementing the process for illustrative embodiments are located. In one embodiment, FIG. 7 represents a server computing device, such as a server, which implements the cognitive system 100 described herein.

In the depicted example, data processing system 700 can employ a hub architecture including a north bridge and memory controller hub (NB/MCH) 701 and south bridge and input/output (I/O) controller hub (SB/ICH) 702. Processing unit 703, main memory 704, and graphics processor 705 can be connected to the NB/MCH 701. Graphics processor 705 can be connected to the NB/MCH 701 through, for example, an accelerated graphics port (AGP).

In the depicted example, a network adapter 706 connects to the SB/ICH 702. An audio adapter 707, keyboard and mouse adapter 708, modem 709, read only memory (ROM) 710, hard disk drive (HDD) 711, optical drive (e.g., CD or DVD) 712, universal serial bus (USB) ports and other communication ports 713, and PCI/PCIe devices 714 may connect to the SB/ICH 702 through bus system 716. PCl/PCIe devices 714 may include Ethernet adapters, add-in cards, and PC cards for notebook computers. ROM 710 may be, for example, a flash basic input/output system (BIOS). The HDD 711 and optical drive 712 can use an integrated drive electronics (IDE) or serial advanced technology attachment (SATA) interface. A super I/O (SIO) device 715 can be connected to the SB/ICH 702.

An operating system can run on processing unit 703. The operating system can coordinate and provide control of various components within the data processing system 700. As a client, the operating system can be a commercially available operating system. An object-oriented programming system, such as the Java™ programming system, may run in conjunction with the operating system and provide calls to the operating system from the object-oriented programs or applications executing on the data processing system 700. As a server, the data processing system 700 can be an IBM® eServer™ System p® running the Advanced Interactive Executive operating system or the Linux operating system. The data processing system 700 can be a symmetric multiprocessor (SMP) system that can include a plurality of processors in the processing unit 703. Alternatively, a single processor system may be employed.

Instructions for the operating system, the object-oriented programming system, and applications or programs are located on storage devices, such as the HDD 711, and are loaded into the main memory 704 for execution by the processing unit 703. The processes for embodiments of the question and answer system pipeline 108, described herein, can be performed by the processing unit 703 using computer usable program code, which can be located in a memory such as, for example, main memory 704, ROM 710, or in one or more peripheral devices.

A bus system 716 can be comprised of one or more busses. The bus system 716 can be implemented using any type of communication fabric or architecture that can provide for a transfer of data between different components or devices attached to the fabric or architecture. A communication unit such as the modem 709 or the network adapter 706 can include one or more devices that can be used to transmit and receive data.

Those of ordinary skill in the art will appreciate that the hardware depicted in FIG. 7 may vary depending on the implementation. Other internal hardware or peripheral devices, such as flash memory, equivalent non-volatile memory, or optical disk drives may be used in addition to or in place of the hardware depicted. Moreover, the data processing system 700 can take the form of any of a number of different data processing systems, including but not limited to, client computing devices, server computing devices, tablet computers, laptop computers, telephone or other communication devices, personal digital assistants, and the like. Essentially, data processing system 700 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112(f) unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A computer implemented method for answering general questions in an information handling system capable of answering questions, the system comprising a processor and a memory comprising instructions executed by the processor, the method comprising:
receiving a general question template and one or more sets of slot fillers with weights by a user;
combining the one or more sets of slot fillers with the general question template to form questions;
running the questions to obtain answers;
aggregating the answers based on the weights; and
returning at least one answer to the question to the user.

2. The method of claim 1, further comprising:
providing a user interface (UI) allowing the user to adjust the one or more sets of slot fillers and weights;
responsive to the user utilizing the UI to form one or more adjusted sets of slot fillers and adjusted weights, combining the one or more adjusted sets of slot fillers to form adjusted questions;
running the adjusted questions to obtain adjusted answers; and
aggregating the adjusted answers based on the adjusted weights.

3. The method of claim 2, further comprising:
forming a weighted question batch comprising the questions and corresponding question weights, each of the question weights generated by combining weights of slot fillers from the one or more sets of slot fillers that form a respective question.

4. The method of claim 1, wherein the answers comprise evidence references.

5. The method of claim 1, wherein the information handling system supports open-domain questions.

6. The method of claim 1, wherein the general question template includes blanks, and wherein each of the one or more sets of slot fillers corresponds to a respective blank in the general question template.

7. The method of claim 1, wherein the answers are aggregated according to scores to the answers and weights of the questions.

8. A computer program product for answering general questions in an information handling system capable of answering questions, the computer program product comprising a computer readable storage medium having program instructions embodied therewith, the program instructions executable by a processor to cause the processor to:
receive a general question template and one or more sets of slot fillers with weights by a user;
combine the one or more sets of slot fillers with the general question template to form questions;
run the questions to obtain answers;
aggregate the answers based on the weights; and
return at least one answer to the question to the user.

9. The computer program product of claim 8, wherein the program instructions further cause the processor to:
provide a user interface (UI) allowing the user to adjust the one or more sets of slot fillers and weights;
responsive to the user utilizing the UI to form one or more adjusted sets of slot fillers and adjusted weights, combine the one or more adjusted sets of slot fillers to form adjusted questions;
run the adjusted questions to obtain adjusted answers; and
aggregate the adjusted answers based on the adjusted weights.

10. The computer program product of claim 9, wherein the program instructions further cause the processor to:
form a weighted question batch comprising the questions and corresponding question weights, each of the question weights generated by combining weights of slot fillers from the one or more sets of slot fillers that form a respective question.

11. The computer program product of claim 8, wherein the information handling system supports open-domain questions.

12. The computer program product of claim 8, wherein the general question template includes blanks, and wherein each of the one or more sets of slot fillers corresponds to a respective blank in the general question template.

13. The computer program product of claim 8, wherein the answers are aggregated according to scores to the answers and weights of the questions.

14. A system for answering general questions, the system comprising:
a memory comprising executable instructions; and
a processor configured to execute the executable instructions causing the processor to:
receive a general question template and one or more sets of slot fillers with weights by a user;
combine the one or more sets of slot fillers with the general question template to form questions;
run the questions to obtain answers;
aggregate the answers based on the weights; and
return at least one answer to the question to the user.

15. The system of claim 14, wherein the executable instructions further cause the processor to:
provide a user interface (UI) allowing the user to adjust the one or more sets of slot fillers and weights;
responsive to the user utilizing the UI to form one or more adjusted sets of slot fillers and adjusted weights, combine the one or more adjusted sets of slot fillers to form adjusted questions;
run the adjusted questions to obtain adjusted answers; and
aggregate the adjusted answers based on the adjusted weights.

16. The system of claim 15, wherein the executable instructions further cause the processor to:
form a weighted question batch comprising the questions and corresponding question weights, each of the question weights generated by combining weights of slot fillers from the one or more sets of slot fillers that form a respective question.

17. The system of claim 14, wherein the answers comprise evidence references.

18. The system of claim 14, wherein the information handling system supports open-domain questions.

19. The system of claim 14, wherein the general question template includes blanks, and wherein each of the one or more sets of slot fillers corresponds to a respective blank in the general question template.

20. The system of claim 14, wherein the answers are aggregated according to scores to the answers and weights of the questions.
